(19) United States
(12) Patent Application Publication
(10) Pub. No.: US 2025/0110384 A1
(43) Pub. Date: Apr. 3, 2025

(54) VIBRATION TYPE ACTUATOR, OPTICAL APPARATUS, AND ELECTRONIC APPARATUS

(71) Applicant: CANON KABUSHIKI KAISHA, Tokyo (JP)

(72) Inventors: KEI SUEFUJI, Tokyo (JP); MEI INOUE, Kanagawa (JP)

(21) Appl. No.: 18/896,629

(22) Filed: Sep. 25, 2024

(30) Foreign Application Priority Data
Sep. 29, 2023 (JP) 2023-169958

(51) Int. Cl. G03B 5/00; G03B 3/10

(52) U.S. Cl. CPC G03B 5/00; G03B 3/10; G03B 2205/0046; G03B 2205/0061

(57) ABSTRACT

A vibration type actuator including a vibration member including an electro-mechanical energy conversion element and an elastic member, and a contact member in contact with the vibration member, wherein the vibration member and the contact member are configured to relatively move in a first direction, includes a base, a holding member held by the base and configured to hold the vibration member, a rotation member including a rotation shaft held by the base and extending in a second direction intersecting with the first direction, and configured to be in contact with the holding member and rotate in association with the relative movement of the vibration member, and an output portion held by the base to be movable in a third direction intersecting with the second direction, and configured to be in contact with the rotation member and move in association with a rotation of the rotation member.

### BACKGROUND

### Field

The present disclosure relates to a vibration type actuator, an optical apparatus, and an electronic apparatus.

### Description of the Related Art

In general, a vibration type actuator generates a driving force by pressure-contacting a vibration member and a driven member to relatively friction-drive the vibration member and the driven member by vibrations excited in the vibration member. For this reason, the vibration type actuator has a simple structure and a thin shape, and can be driven highly accurately and quietly. The vibration type actuator has been applied as a driving motor to a rotational driving apparatus, such as a lens barrel and a pan head, a production apparatus, such as a factory automation (FA) apparatus, and an office automation (OA) apparatus.

For example, there is known a vibration type actuator including a driven member, a vibration member provided with two protrusions protruding from one of surfaces (front surface) of a flat plate type elastic member and a piezoelectric element joined to the other surface (rear surface) of the elastic member, and a pressing member for pressure-contacting the two protrusions and the driven member (contact member). Here, the rear surface of the elastic member refers to a surface with no protrusions (described below) formed thereon. In addition, the driven member may also be referred to as a “contact member”.

Predetermined alternating voltages (hereinbelow, also referred to as driving voltages) are applied to an electro-mechanical energy conversion element in the vibration type actuator having the above-described structure. Applying the alternating voltages generates elliptical motions or circular motions at leading ends of the two protrusions in a plane including a direction connecting the two protrusions and a protruding direction of the protrusions. With this operation, the contact member receives a frictional driving force from the two protrusions (vibration member) to enable the vibration member and the contact member to relatively move in the direction connecting the two protrusions.

As a vibration type actuator of a direct operation type that performs a translational motion, there is known a configuration to obtain an output of a movement amount equivalent to the relative movement between the contact member and the vibration member in a direction of the relative movement via an output portion connected to any one of the contact member and the vibration member, using the relative movement between the contact member and the vibration member. For example, Japanese Patent Application Laid-open No. 2023-19753 discusses a configuration in which a contact member and a vibration member relatively move to move an output portion fixed to a holding member holding the vibration member by a relative movement between the contact member and the vibration member.

However, with the vibration type actuator described above as the conventional example, since the rectangular shape vibration member elongated in one direction and having the two protrusions is used, the direction of the output motion (output direction) is limited to an output direction the same as a longer side direction of the vibration member. Further, since the relative movement of the vibration member and the contact member is used as the output, the movement amount to be output is limited to the movement amount of the relative movement.

### SUMMARY

The present disclosure advantageously provides a vibration type actuator with improved design flexibility. Another advantage of the present disclosure is to provide an optical apparatus and an electronic apparatus including the vibration type actuator with improved design flexibility.

According to some embodiments, a vibration type actuator including a vibration member including an electro-mechanical energy conversion element and an elastic member, and a contact member in contact with the vibration member, wherein the vibration member and the contact member are configured to relatively move in a first direction, includes a base, a holding member held by the base and configured to hold the vibration member, a rotation member including a rotation shaft held by the base and extending in a second direction intersecting with the first direction, and configured to be in contact with the holding member and rotate in association with the relative movement of the vibration member, and an output portion held by the base to be movable in a third direction intersecting with the second direction, and configured to be in contact with the rotation member and move in association with a rotation of the rotation member.

Further features of the present disclosure will become apparent from the following description of exemplary embodiments with reference to the attached drawings.

### BRIEF DESCRIPTION OF THE DRAWINGS

FIG. 1 is a perspective view illustrating a schematic configuration of a vibration type actuator according to a first exemplary embodiment of the present disclosure.

FIG. 2 is an exploded perspective view of the vibration type actuator illustrated in FIG. 1.

FIGS. 3A and 3B are perspective views respectively illustrating a first vibration mode and a second vibration mode excited in a vibration member included in the vibration type actuator illustrated in FIG. 1.

FIGS. 4A and 4B are diagrams illustrating the vibration type actuator illustrated in FIG. 1 as viewed in an XZ plane, and the vibration type actuator as viewed in an XY plane, respectively.

FIGS. 5A, 5B, and 5C are diagrams of the vibration type actuator as viewed in the XY plane when the vibration member is located at a left end of a stroke, when the vibration member is located at a center of the stroke, and when the vibration member is located at a right end of the stroke, respectively.

FIG. 6 is a diagram illustrating a vibration type actuator as viewed in the XY plane according to a modification example of the first exemplary embodiment of the present invention.

FIGS. 7A and 7B are diagrams illustrating a vibration type actuator according to a second exemplary embodiment as viewed in an XZ plane and as viewed in the XY plane, respectively.

FIGS. 8A, 8B, and 8C are diagrams illustrating the vibration type actuator illustrated in FIGS. 7A and 7B as viewed in the XY plane when a vibration member is located at a left end of a stroke, when the vibration member is located at a center of the stroke, and when the vibration member is located at a right end of the stroke, respectively.

FIG. 9 is a perspective view illustrating a vibration type actuator according to a third exemplary embodiment of the present disclosure.

FIG. 10 is a perspective view illustrating a vibration type actuator according to a modification example of the third exemplary embodiment of the present disclosure.

FIG. 11 is a top view illustrating a schematic configuration of an imaging apparatus including the vibration type actuator.

### DESCRIPTION OF THE EMBODIMENTS

Hereinbelow, the present disclosure will be described in more detail using various exemplary embodiments, features, and aspects with respect to the drawings.

In the vibration type actuator that performs a translational movement, since the rectangular vibration member having two protrusions and elongated in one direction is used, the direction of the output motion (output direction) is limited to an output direction the same as the longer side direction of the vibration member. Further, since the relative movement of the vibration member and the contact member is used as the output, the movement amount to be output is limited to the movement amount of the relative movement. Thus, the inventors of the present disclosure have investigated methods to enhance the design flexibility of the vibration type actuator. As a result, the inventors have found that the output direction of the vibration type actuator can be converted by providing a rotation member having a rotation shaft extending in a second direction intersecting with a direction (first direction) of the relative movement between the vibration member and the contact member, whereby the design flexibility can be enhanced.

The rotation member is held by a base and is in contact with a holding member holding the vibration member, and thus, the vibration member rotates around the rotation shaft extending in the second direction in association with the relative movement between the vibration member and the contact member. Further, the rotation member is in contact with the output portion held by the base in a movable manner in a third direction intersecting with the second direction, and thus, the output portion moves in association with the rotation of the rotation member. In this way, the present disclosure can convert the output of the vibration type actuator, and as a result, the design flexibility can be enhanced.

Furthermore, in the conventional technique, the size of the vibration type actuator is preferably larger than the driving amount of the vibration member in the driving direction. However, even in a configuration of performing minute driving, the size of the vibration type actuator in the output direction can also be made compact by converting the output direction.

Examples of configurations according to the present disclosure will be described in detail below as exemplary embodiments.

### [Configuration of Vibration Type Actuator]

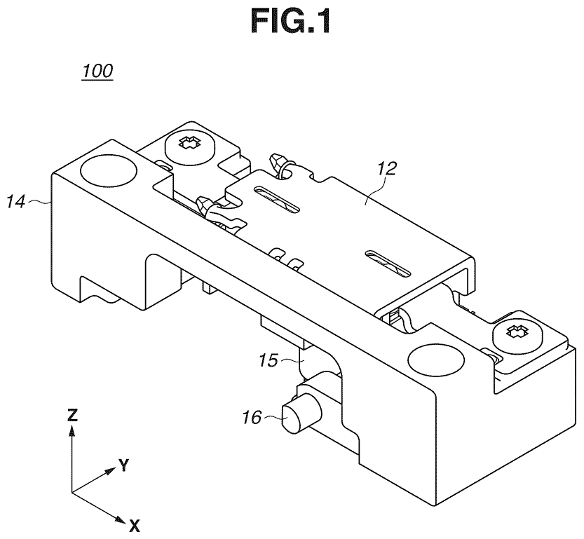

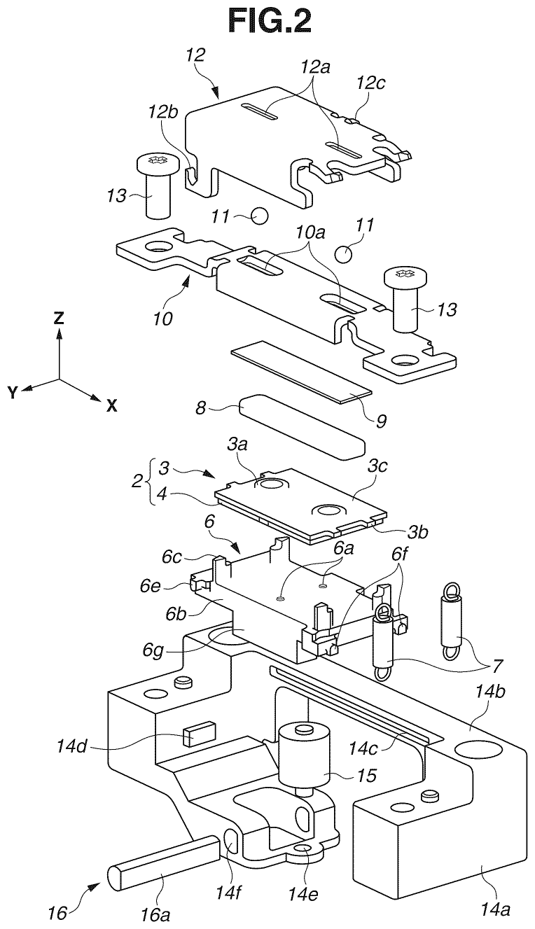

FIG. 1 is a perspective view illustrating a schematic configuration of a vibration type actuator 100 according to a first exemplary embodiment of the present disclosure. FIG. 2 is an exploded perspective view illustrating the vibration type actuator 100.

The vibration type actuator 100 includes a vibration member 2, a holding member 6, pressurizing springs 7, a contact member 8, a vibration-damping rubber 9, a first guide member 10, a second guide member 12, screws 13, a base 14, a rotation member 15, and an output portion 16.

The vibration member 2 includes an elastic member 3, a piezoelectric element 4, and a flexible printed circuit board (not illustrated).

The elastic member 3 includes a rectangular main member 3c, two protrusions 3a provided on one surface of the elastic member 3, and a plurality of extending portions 3b (four extending portions in the present exemplary embodiment) extending from a plurality of positions in the main member 3c (two positions in the present exemplary embodiment) in an X direction. The plurality of the extending portions 3b extends from the plurality of positions in the main member 3c (four positions in the present exemplary embodiment) different in the X direction and a Y direction.

The piezoelectric element 4, which is an electro-mechanical energy conversion element that converts an electrical energy into a mechanical energy, is bonded by an adhesive onto a surface of the elastic member 3 that is opposite to the surface on which the protrusions 3a are provided. The piezoelectric element 4 is configured to have electrodes having a predetermined shape on both sides of a piezoelectric ceramic plate. Further, the flexible printed circuit board (not illustrated) is fixed to a surface of the piezoelectric element 4 opposite to the surface to which the elastic member 3 is fixed. Driving voltages (alternating voltages) with a predetermined frequency are applied from the flexible printed circuit board to the respective electrodes of the piezoelectric element 4.

The elastic member 3 is an elastic member made of metal, and for example, martensite stainless steel is used as a material. In addition, as a hardening treatment to increase the durability, the elastic member 3 is subjected to, for example, a quenching treatment. The protrusions 3a are formed integrally with the elastic member 3 by, for example, performing press work on a plate material configuring the elastic member 3. In this case, the protrusions 3a are formed with a predetermined thickness to have a spring property. However, the configuration is not limited thereto, and the protrusions 3a may be fixed to the elastic member 3 by welding or the like. Since the leading edges (upper surfaces) of the protrusions 3a frictionally slide with the contact member 8, they are subjected to hardening treatment, such as quenching treatment, to increase their wear resistance.

Now, the X direction, the Y direction, and a Z direction will be defined. The X direction is a direction connecting the leading edges of the two protrusions 3a of the vibration member 2, and is also a longer side direction of the vibration member 2. The Z direction is a protruding direction of the protrusions 3a of the vibration member 2, and is also a direction in which the vibration member 2 and the contact member 8 are in pressure-contact with each other. The Y direction is a direction orthogonal to the X direction and the Z direction, and is also a shorter side direction of the vibration member 2. In addition, in the present specification, an upper side and a lower side correspond to an upward direction and a downward direction in the Z direction, respectively.

Next, a pressurizing mechanism according to the present exemplary embodiment will be described. The holding member 6 for pressurizing and holding the vibration member 2 is provided on the lower side of the vibration member 2, and the second guide member 12 is provided on the upper side of the vibration member 2. Pressurizing fulcrums 6e provided at two positions in the holding member 6 on its one end in the X direction, and fitting portions 12b provided at two positions in the second guide member 12 fit each other to be rotatable around a Y axis direction.

Further, the pressurizing springs 7 are respectively provided between the second guide member 12 and spring setting portions 6f provided on the other end of the holding member 6 in the X direction. As the pressurizing springs 7, for example, tensile coil springs can be used. Two protruded portions 6a are provided at an approximately center position on the holding member 6 between the pressurizing fulcrums 6e and the pressurizing springs 7 in the X direction, and the two protruded portions 6a are in contact with the vibration member 2.

As described above, in the pressurizing mechanism according to the present exemplary embodiment, the pressurizing force is applied to the vibration member 2 in the Z direction based on the principle of leverage, and the pressurizing fulcrums 6e sever as fulcrums, the spring setting portions 6f serve as points of effort, and the protruded portions 6a serve as points of action. Further, the contact member 8 is provided on the upper side of the vibration member 2, and is pressurized in the Z direction to be in contact with the protrusions 3a of the elastic member 3 due to the pressurizing force applied to the vibration member 2 by the pressurizing mechanism. With the pressurizing mechanism, described above, the vibration member 2, the holding member 6, and the second guide member 12 can move together in the X direction. A rotation member reception portion 6g provided on a surface of the holding member 6 opposite to the surface on which the protruded portions 6a are provided will be described below.

In addition, in the present exemplary embodiment, the pressurizing fulcrums 6e are provided on the one end of the holding member 6 in the X direction, and the spring setting portions 6f are provided on the other end of the holding member 6. However, the pressurizing fulcrums 6e and the spring setting portions 6f are not limited to the configuration of being provided on the ends in the X direction of the of the holding member 6, and the pressurizing fulcrums 6e and the spring setting portions of may be provided at positions capable of functioning as the fulcrums and the points of effort in the principle of leverage with the protruded portions 6a as the points of action.

On the upper side of the contact member 8, the vibration-damping rubber 9, the first guide member 10, and the second guide member 12 are provided. The contact member 8 is fixed to the first guide member 10 by the adsorption force of the vibration-damping rubber 9. The vibration-damping rubber 9 is made of, for example, butyl rubber or silicone rubber with a high vibration damping performance, and unnecessary vibrations are prevented by the vibration-damping rubber 9 from being generated in the contact member 8 while the vibration type actuator 100 is driven. Accordingly, the generation of abnormal sounds can be reduced, and the decrease of the output can be prevented. Further, the vibration-damping rubber 9 also acts as a vibration insulator that prevents the vibrations generated by the vibration member 2 from being easily transmitted to the first guide member 10.

The first guide member 10 is fixed to the base 14 serving as a fixing member with the screws 13. In addition, the contact member 8, the first guide member 10, and the vibration-damping rubber 9 may be fixed by bonding with an adhesive or fastening with screws. The contact member 8 is made of a metal material, such as stainless steel, and is subjected to hardening treatment, such as nitriding treatment, on its friction sliding surface sliding against the protrusions 3a, to increase the wear resistance.

The first guide member 10 and the second guide member 12 provided as a guide mechanism are provided with two rolling grooves 10a and two rolling grooves 12a, respectively, so as to sandwich two rolling balls 11 therebetween. With this configuration, since the rolling balls 11 roll in the rolling grooves 10a and 12a when the vibration type actuator 100 is driven, the vibration member 2, the holding member 6, and the second guide member 12 can move smoothly in the X direction. The first guide member 10 and the second guide member 12 may have a predetermined hardness or more because the first guide member 10 and the second guide member 12 receive the pressurizing forces at the rolling grooves 10a and the rolling grooves 12a, respectively. Thus, from the viewpoint of processibility, metal is used, and among the metals, stainless steel is used in particular.

The base 14 is provided with screw holes and retaining portions to fix the first guide member 10, and includes two fixed portions 14a provided with holes and the like to fix the base 14 to a target apparatus to be driven, a connection portion 14b connecting the two fixed portions 14a, a groove portion 14c, and collision prevention portions 14d. The groove portion 14c is formed in a part of the connection portion 14b along the X direction. The groove portion 14c and an inclination restriction portion 12c provided on the second guide member 12 fit together loosely, i.e., fit together with predetermined play, to restrict the rotation of the vibration member 2 and the like around an X axis.

The collision prevention portions 14d extend toward the holding member 6 side from the fixed portions 14a in the X direction, to prevent the pressurizing fulcrums 6e and the spring setting portions 6f of the holding member 6 from colliding with the fixed portions 14a, when the holding member 6 moves. In addition, from the viewpoint of processibility and slidability, the base 14 is formed of a resin material.

### [Driving Principal of Vibration Type Actuator]

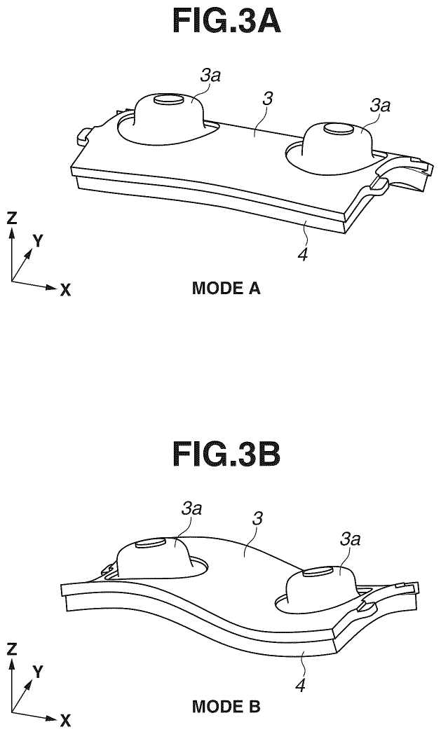

Next, with reference to FIGS. 3A and 3B, vibration modes excited in the vibration member 2 will be described. In the present exemplary embodiment, alternate current (AC) voltages are applied to the piezoelectric element 4 via the flexible printed circuit board to excite standing waves (out-of-plane bending vibrations) different in phase from each other in the vibration member 2, to generate vibrations combined with the out-of-plane bending vibrations. FIG. 3A illustrates the vibration member 2 vibrating in a mode A (i.e., first vibration mode), and FIG. 3B illustrates the vibration member 2 vibrating in a mode B (i.e., second vibration mode).

The mode A (i.e., first vibration mode) is a primary out-of-plane bending vibration mode in which two nodes appear in a direction parallel to the X direction (longer side direction) of the vibration member 2. With the vibration in the mode A, the two protrusions 3a are displaced in the Z direction (pressurizing direction). The mode B (i.e., second vibration mode) is a secondary out-of-plane bending vibration mode in which three nodes appear in a direction approximately parallel to the Y direction (shorter side direction) of the vibration member 2. With the vibration in the mode B, the two protrusions 3a are displaced in the X direction.

By combining the vibrations of the mode A and the mode B, the two protrusions 3a performs elliptical motions or circular motions in the XZ plane. Pressure-contacting the contact member 8 to the protrusions 3a generates a friction force in the X direction, which generates a driving force to relatively move the vibration member 2 and the contact member 8. In the present exemplary embodiment, as described above, since the contact member 8 is fixed to the base 14, the vibration member 2 moves in the X direction. In other words, the vibration member 2 moves in a direction the same as the longer side direction of the rectangular vibration member 2.

In order to efficiently drive the vibration type actuator 100, it is preferable to support the vibration member 2 so as not to hinder the vibrations of the two vibration modes to be excited in the vibration member 2, and thus, it is desirable to support the vicinities of the nodes of the two vibration modes. For this reason, the two protruded portions 6a are provided on the holding member 6 so as to pressurize and hold the common nodes of the two vibration modes excited in the vibration member 2. Further, by positioning the vibration member 2 in the X direction and the Y direction with the retaining portions 6c provided on the holding member 6, the two protruded portions 6a can be brought into contact with the vibration member 2 at the vicinities of the nodes of the two vibration modes.

Further, the protruded portions 6a not only pressurize the vibration member 2, but also hold the vibration member 2 in the X direction and the Y direction by a frictional force. In the present exemplary embodiment, the vibration member 2 does not move relative to the holding member 6, because the maximum value of the static frictional force between the protruded portions 6a and the vibration member 2 is constantly larger than the reaction force received by the vibration member 2 from the contact member 8 when the vibration member 2 is driven. In this way, it is possible to drive the vibration actuator with higher accuracy.

### [Output Transmission Mechanism]

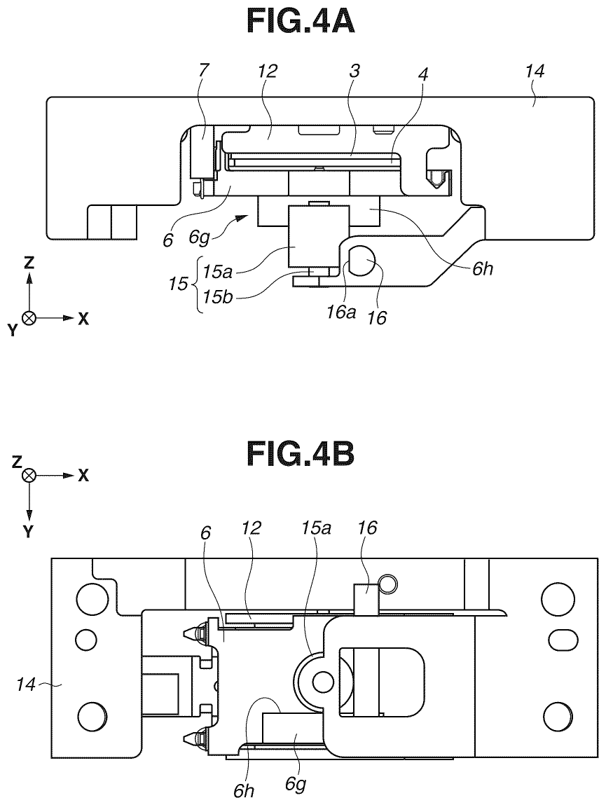

Next, with reference to FIGS. 2, 4A, and 4B, an output transmission mechanism according to the present exemplary embodiment will be described.

FIG. 4A is a diagram illustrating the vibration type actuator 100 viewed in the XZ plane, and FIG. 4B is a diagram illustrating the vibration type actuator 100 viewed in an XY plane.

The output transmission mechanism according to the present exemplary embodiment includes the rotation member reception portion 6g provided on the holding member 6, the rotation member 15, and the output portion 16.

The rotation member 15 includes a roller portion 15a, which is a roller-shaped rotation portion serving as a smooth roller, and a rotation member shaft 15b. The roller portion 15a is a metal roller rotatable around the Z axis, which is the axial direction of the rotation member shaft 15b. Further, the roller portion 15a is in contact with a rotation member contact surface 6h of the rotation member reception portion 6g of the holding member 6. The rotation member contact surface 6h is a surface parallel to the XZ plane formed by a driving direction of the vibration type actuator 100 and the pressurizing direction, and is a smooth surface. In addition, the roller portion 15a is not limited to the metal roller, and may be a rubber roller or a resin roller selected as appropriate based on the environment or the magnitude of the thrust force.

The rotation member shaft 15b is fixed to a shaft fixing portion 14e of the base 14 at a position to urge the rotation member contact surface 6h and the roller portion 15a with a predetermined force in the Y axis direction. In this way, the vibration type actuator 100 is driven to move the holding member 6 in the X direction (i.e., first direction). The roller portion 15a of the rotation member 15 rolls on the rotation member contact surface 6h by an amount corresponding to the movement amount and rotates around the Z axis with respect to the rotation member shaft 15b, which is a rotation shaft extending in the Z axis direction (i.e., second direction).

In this case, the rotation member 15 is desirably arranged to be located on the inner side of a position where the holding member 6 is located in the Y direction and the X direction. In other words, it is desirable for the rotation member 15 to be shorter in length than the holding member 6 in the Y direction and to be located at a position inside the area occupied by the holding member 6.

It is more desirable that the rotation member 15 is shorter in length than the holding member 6 in the Y direction and the X direction and to be located inside an area projected by the holding member 6, in a plane including the Y direction and the X direction. With this configuration, even if the rotation member 15 is provided, it is possible to prevent the vibration type actuator 100 from increasing in size and keep its shape compact.

The output portion 16 has a D cut surface 16a as a part of its surface, which is a flat surface parallel to the YZ plane, and is supported to be movable in the Y direction with respect to an output guide portion 14f of the base 14. Further, the D cut surface 16a supports the output portion 16 so as not to be able to rotate around the Y axis with respect to the output guide portion 14f.

The D cut surface 16a is arranged to be in contact with the roller portion 15a of the rotation member 15 and also to be pressurized with a predetermined force in the X axis direction. With this configuration, when the roller portion 15a rotates around the Z axis, the output portion 16 performs a translational movement by an amount corresponding to the rotation amount of the roller portion 15a in the Y direction.

More specifically, when the vibration type actuator 100 is driven to translate the holding member 6 in the X direction, the roller portion 15a of the rotation member 15 that is in contact with the rotation member reception portion 6g rotates around the Z axis, and the output portion 16 that is in contact with the roller portion 15a translates in the Y direction (i.e., third direction). In this way, the translational movement of the vibration type actuator 100 in the X direction is converted into the translational movement of the output portion 16 in the Y direction at a ratio of 1:1, and is output. In addition, the third direction in the present exemplary embodiment is the Y direction, but the output direction of the output portion 16 is not limited to the Y direction. More specifically, the configuration is not limited to the configuration in which the vibration member 2 and the contact member 8 performs the relative translational movement in the X direction (i.e., first direction), and the output portion 16 performs the translational movement in the Y direction that is approximately orthogonal to the X direction, and the output portion 16 may be configured to move in a direction different from the Y direction or an opposite direction in the Y direction.

In this way, the relative movement direction of the vibration member 2 and the contact member 8 of the vibration type actuator 100 can be converted and output, and thus, the design flexibility of the vibration type actuator 100 can be improved.

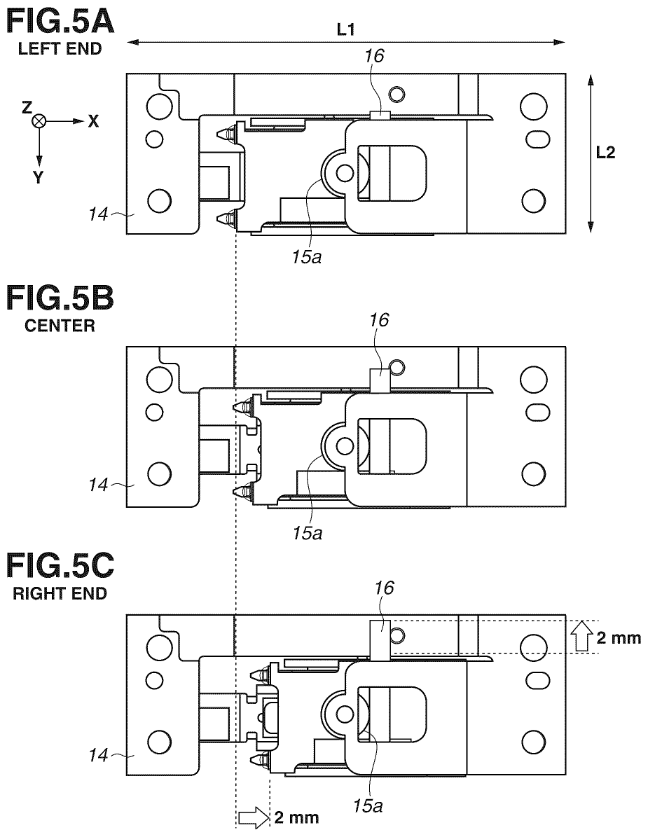

Now, with reference to FIGS. 5A, 5B, and 5C, a driving example of the output portion 16 according to the present exemplary embodiment when the driving amount is set to be 2 millimeters (mm) will be described.

FIGS. 5A, 5B, and 5C are diagrams illustrating the vibration type actuator 100 as viewed in the XY plane when the vibration member 2 is located at a left end of a stroke, when the vibration member 2 is located at a center of the stroke, and when the vibration member 2 is located at a right end of the stroke, respectively.

As illustrated in FIGS. 5A, 5B, and 5C, when the vibration member 2 relatively moves with respect to the contact member 8 in the X direction from the left end toward the right end by 2 millimeters (mm), the roller portion 15a of the rotation member 15 rotates counterclockwise around the Z axis, and the output portion 16 moves in the Y direction by 2 mm from the lower side to the upper side in FIGS. 5A, 5B, and 5C. On the other hand, when the vibration member 2 moves from the right end toward the left end by 2 mm, the roller portion 15a of the rotation member 15 rotates clockwise around the Z axis, and the output portion 16 moves in the Y direction by 2 mm from the upper side toward the lower side in FIGS. 5A, 5B, and 5C.

In other words, the relative movement between the vibration member 2 and the contact member 8 of the vibration type actuator 100 in the X direction is converted into the translational movement of the output portion 16 in the Y direction at a ratio of 1:1, and is output, by the rolling of the roller portion 15a of the rotation member 15.

A dimension L1 of the vibration type actuator 100 in the X direction, which is the relative movement direction of the vibration member 2 and the contact member 8 is large compared with the stroke, because the contact member 8 and the first guide member 10 may have a certain length in the X direction. Further, in the case where the two protrusions 3a are provided on the vibration member 2 as in the present exemplary embodiment, the contact member 8 may preferably be constantly in contact with the two protrusions 3a. Accordingly, since the contact member 8 may preferably be made larger in the X direction by the length between the protrusions 3a in addition to the stroke, the dimension L1 further increases.

On the other hand, a dimension L2 of the vibration type actuator 100 in the Y direction, which is the output direction of the output portion 16, is determined by the size of the vibration member 2 in the Y direction and the size of the connection portion 14b of the base 14 in the Y direction, and the dimension L2 is very small compared with the dimension L1 in the X direction.

With this configuration, in the case where the driving amount is set to 2 mm as in the present exemplary embodiment, since the moving range of the output portion 16 falls within the dimension L2 of the base 14, it is possible to achieve the compact size of the vibration type actuator 100 in the output direction.

In a case where an optical apparatus, such as a lens barrel, is to be driven, there has been a limitation in reducing the size of a lens barrel according to the conventional technique, even if the lens barrel has been desired to be thin in the optical axis direction, because the relative movement direction between the vibration member 2 and the contact member 8 of the vibration type actuator 100, and the output direction of the vibration type actuator 100 coincide with each other.

On the other hand, as in the present exemplary embodiment, by converting the driving in the relative movement direction of the vibration member 2 and the contact member 8 of the vibration type actuator 100 into output (movement) in the Y direction, the Y direction of the vibration type actuator 100 can be arranged in the optical axis direction of the lens barrel. In this way, it is possible to achieve the compactness of the lens barrel in the optical axis direction. Further, since the X direction of the vibration type actuator 100 can be arranged in the radial direction of the lens barrel that there is relatively enough space, it is possible to prevent the lens barrel from becoming large in the radial direction.

Further, in the present exemplary embodiment, the conversion of the output direction is achieved by the rolling of the roller portion 15a. Thus, since the movement of the vibration member 2 can be transmitted to the output portion 16 smoothly, a highly accurate and quiet driving with good controllability of the vibration type actuator 100 can be achieved. In addition, in order to drive the vibration type actuator 100 highly accurately, the frictional force between the rotation member contact surface 6h and the roller portion 15a, and the frictional force between the D cut portion 16a of the output portion 16 and the roller portion 15a are made sufficiently larger than the thrust force to be generated so that the force by the rolling of the roller portion 15a can be constantly transmitted without slipping.

In the present exemplary embodiment, the roller portion 15a is urged against the output portion 16 by the urging force generated by holding the roller portion 15a at a predetermined position so that the roller portion 15a is located at a position at which a desired frictional force can be obtained. However, the configuration is not limited thereto, and the roller portion 15a may be urged against the output portion 16 by an urging force of a spring or an attractive force of a magnet.

Further, in the present exemplary embodiment, an encoder for detecting the rotation position of the roller portion 15a of the rotation member 15 may be provided. With this encoder, the amount of rotation can be detected, so that the driving amount of the vibration type actuator 100 in the translational direction can be detected.

Conventionally, the encoder used for the translational driving may preferably use a certain amount of space, because a scale, which is a detected portion of the encoder, having a length corresponding to the stroke in the driving direction may preferably be provided. In the present exemplary embodiment, since the translational motion is converted into a rotational motion, and further converted into a translational motion, the final movement amount in the translational motion can be detected by detecting the rotation amount. Thus, since the length of the scale corresponding to the stroke of the translation driving amount is not needed, the rotation amount may preferably be detected. In this way, it is possible to achieve the more compact vibration type actuator 100 that can detect the position of the vibration type actuator 100.

In addition, in the present exemplary embodiment, the stroke is set to 2 mm, but it is not limited thereto, and a stroke may be selected and applied as appropriate according to a driving target.

Further, in the present exemplary embodiment, the driving direction is converted by transmission of the rotation by the rolling of the roller portion 15a, but the present exemplary embodiment is not limited to the configuration.

### Modification Example

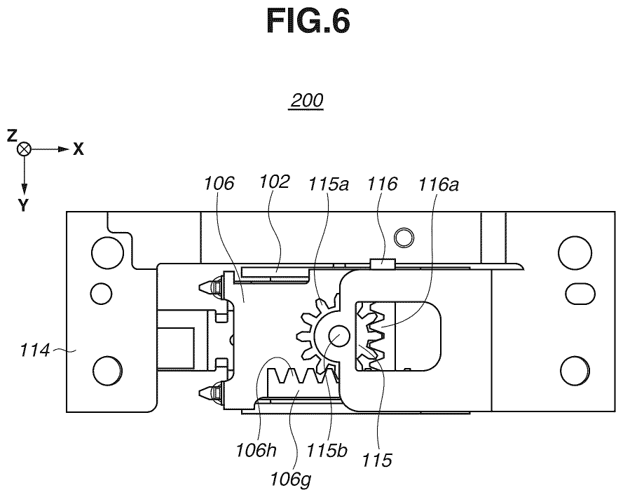

FIG. 6 is a diagram illustrating a vibration type actuator 200 as viewed in the XY plane according to a first modification example of the vibration type actuator 100 according to the first exemplary embodiment.

As illustrated in FIG. 6, in a case of the vibration type actuator 200 with a relatively low demand for the accuracy of determining the driving position of the vibration type actuator 200 and a demand for a simpler configuration, it is possible to convert the driving direction using a gear and a rack. More specifically, a gear portion 115a, which is a gear-shaped rotation portion, is provided on a rotation member 115, and a gear contact surface 106h, which is a rack portion engaging with and being in contact with the gear portion 115a, is provided on a rotation member reception portion 106g of a holding member 106.

The rotation member 115 includes the gear portion 115a with gear tooth formed thereon, and a rotation member shaft 115b. The gear portion 115a is a resin gear and is rotatable around the Z axis, which is the axial direction of the rotation member shaft 115b. Further, the gear portion 115a engages with the gear contact surface 106h formed on the rotation member reception portion 106g of the holding member 106. The gear contact surface 106h acts on the gear portion 115a as a so-called rack. With this configuration, when the vibration type actuator 200 is driven, and the holding member 106 moves in the X direction, the gear portion 115a of the rotation member 115 rotates around the Z axis with respect to the rotation member shaft 115b by the engagement with the gear contact surface 106h by an amount corresponding to the movement amount of the holding member 106. In addition, the gear portion 115a is not limited to a resin gear, but may be formed of metal or other materials.

An output portion 116 also has a gear contact surface 116a that engages with the gear portion 115a of the rotation member 115, and the gear contact surface 116a functions as a so-called rack. With this configuration, when the gear portion 115a rotates around the Z axis, the output portion 116 performs a translational movement in the Y direction by an amount corresponding to the rotation amount of the roller portion 15a.

More specifically, when the vibration type actuator 200 is driven to translate the holding member 106 in the X direction, the gear portion 115a of the rotation member 115 in contact with the rotation member reception portion 106g rotates around the Z axis, and the output portion 116 in contact with the gear portion 115a performs a translational movement in the Y direction. In this way, the translational movement of the vibration type actuator 200 in the X direction is converted into the translational movement of the output portion 116 in the Y direction at a ratio of 1:1 and is output.

In this way, the relative movement direction of a vibration member 102 and a contact member 108 (not illustrated in FIG. 6) of the vibration type actuator 200 can be converted and output, and thus, the design flexibility of the vibration type actuator 200 can be improved.

Further, since a force is transmitted by using a gear, and a member for applying an urging force or high precision processing is not necessary, compared to a case where a force is transmitted by rolling of a roller, it is possible to make the vibration type actuator 200 more compact and simpler, which reduces production costs. Further, since there is no occurrence of slippage, it is possible to transmit a thrust force larger than in the case where a force is transmitted by rolling of a roller.

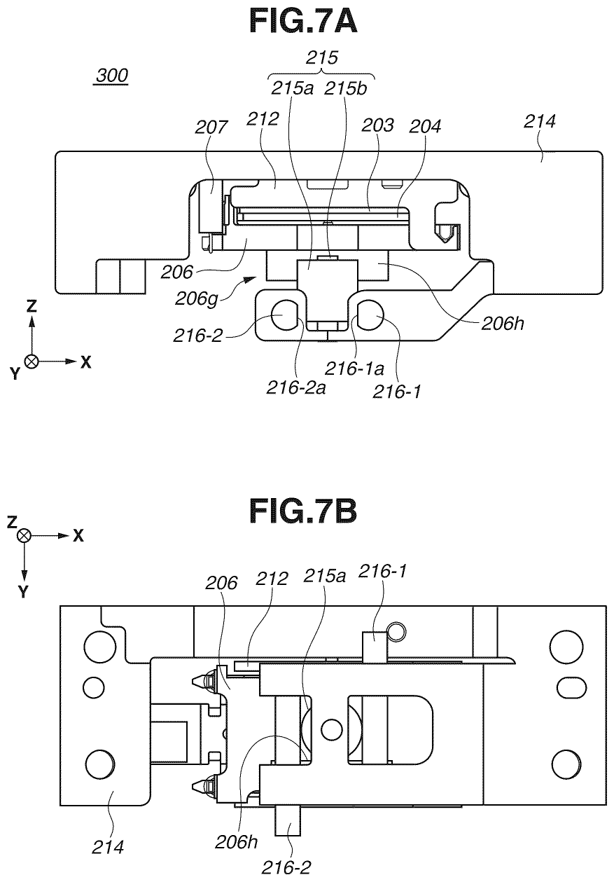

With reference to FIGS. 7A and 7B, a configuration example of a vibration type actuator 300 according to a second exemplary embodiment, which has a configuration different from that according to the first exemplary embodiment, will be described. The configuration of the present exemplary embodiment illustrated in FIGS. 7A and 7B is different from that of the first exemplary embodiment illustrated in FIG. 1 in that two output portions 216 are provided. Other components in the present exemplary embodiment are the same as the corresponding components according to the first exemplary embodiment, and the descriptions thereof are omitted.

FIG. 7A is a diagram illustrating the vibration type actuator 300 according to the present exemplary embodiment as viewed in the XZ plane, and FIG. 7B is a diagram illustrating the vibration type actuator 300 as viewed in the XY plane.

An output transmission mechanism of the vibration type actuator 300 illustrated in FIGS. 7A and 7B includes a rotation member reception portion 206g provided on a holding member 206, a rotation member 215, and two output portions 216-1 and 216-2.

The rotation member 215 includes a roller portion 215a serving as a smooth roller, and a rotation member shaft 215b. The roller portion 215a is rotatable with respect to the rotation member shaft 215b around the Z axis, which is an axial direction of the rotation member shaft 215b. Further, the roller portion 215a is in contact with a rotation member contact surface 206h of the rotation member reception portion 206g of the holding member 206. The rotation member contact surface 206h is a surface parallel to the XZ plane formed by a driving direction and a pressurizing direction of the vibration type actuator 300, and is a smooth surface.

The rotation member shaft 215b is fixed to a shaft fixing portion (not illustrated) of a base 214 at a position to urge the rotation member contact surface 206h and the roller portion 215a with a predetermined force in the Y axis direction. With this configuration, when the vibration type actuator 300 is driven, and the holding member 206 moves in the X direction, the roller portion 215a of the rotation member 215 rotates around the Z axis with respect to the rotation member shaft 215b by rolling on the rotation member contact surface 206h by an amount corresponding to the movement amount of the holding member 206.

The two output portions 216-1 and 216-2 have D cut surfaces 216-1a and 216-2a, respectively, as a part of their surfaces, which are flat surfaces parallel to the YZ plane, and are supported by the base 214 to be slidable with respect to the base 214 in the Y direction, and not to be able to rotate around the Y axis. Further, the two output portions 216-1 and 216-2 are supported so that the D cut surfaces 216-1a and 216-2a face each other in the X direction.

The D cut surfaces 216-1a and 216-2a are arranged to be in contact with the roller portion 215a of the rotation member 215 and to be urged with a predetermined force in the X axis direction. With this configuration, when the roller portion 215a rotates around the Z axis, the output portions 216-1 and 216-2 each perform a translational movement by an amount corresponding to the rotation amount of the roller portion 215a in the Y direction.

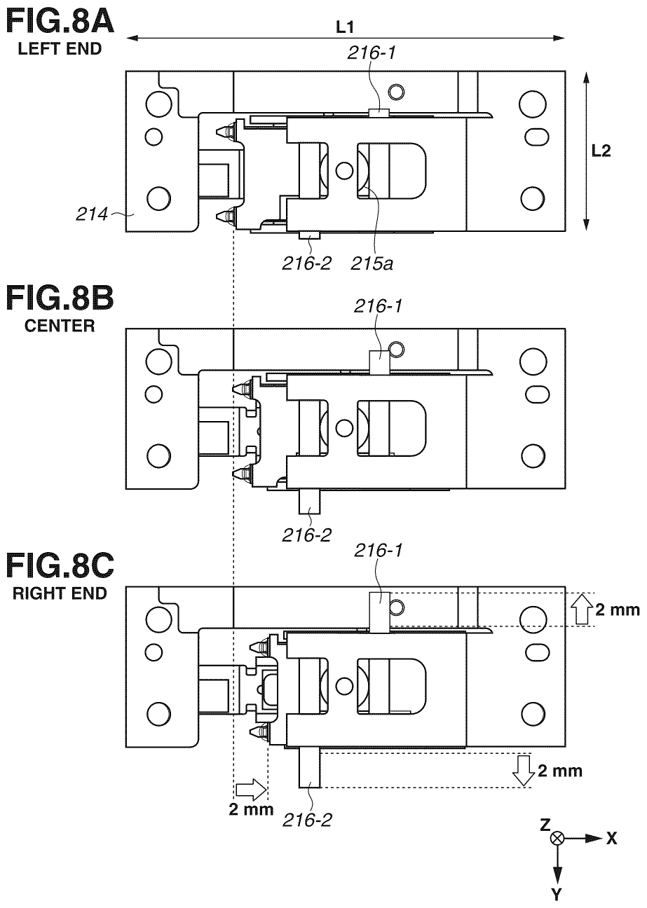

Now, with reference to FIGS. 8A, 8B, and 8C, an example of driving the output portions 216-1 and 216-2 according to the present exemplary embodiment when the driving amount is set to be 2 mm will be described.

FIGS. 8A, 8B, and 8C are diagrams illustrating the vibration type actuator 300 as viewed in the XY plane when a vibration member (not illustrated) is located at a left end of a stroke, when the vibration member is located at a center of the stroke, and when the vibration member is located at a right end of the stroke, respectively.

As illustrated in FIGS. 8A, 8B, and 8C, when the vibration member relatively moves with respect to a contact member (not illustrated) by 2 mm in the X direction (i.e., first direction) from the left end toward the right end, the roller portion 215a of the rotation member 215 rotates counterclockwise around the Z axis that is a rotation axis extending in the second direction. In this way, the output portions 216-1 moves 2 mm from the lower side to the upper side in FIGS. 8A, 8B, and 8C in the Y direction, and the output portions 216-2 moves 2 mm from the upper side to the lower side in FIGS. 8A, 8B, and 8C in the Y direction. On the other hand, when the vibration member moves 2 mm from the right end to the left end, the roller portion 215a of the rotation member 215 rotates clockwise around the Z axis. In this way, the output portion 216-1 moves 2 mm from the upper side to the lower side in FIGS. 8A, 8B, and 8C in the Y direction, and the output portion 216-2 moves 2 mm from the lower side to the upper side in FIGS. 8A, 8B, and 8C in the Y direction.

In other words, the relative movement in the X direction between the vibration member and the contact member of the vibration type actuator 300 is converted into translational movements of the output portions 216-1 and 216-2 in the Y direction at a ratio of 1:1 and is output, by the rolling of the roller portion 215a of the rotation member 215. Further, the output portions 216-1 and 216-2 move in the directions opposite to each other in the Y direction (i.e., third direction).

By using the configuration in which the output portions 216-1 and 216-2 move in the opposite directions, for example, in an electronic apparatus, such as a robot, the open/close operation of a gripper of the robot can be achieved by one vibration type actuator 300. In a case where the vibration type actuator 300 according to the present exemplary embodiment is applied to the gripper of the robot, for example, by providing members constituting the gripper to the output portions 216-1 and 216-2 and driving the members, it is possible to grip a target object between the members and to release the target object. In addition, since the direction of the open/close operation and the relative movement direction of the vibration member and the contact member of the vibration type actuator 300 are orthogonal, it is possible to arrange the vibration type actuator 300 without causing the gripper size to become large in the open/close operation direction.

Further, in the present exemplary embodiment, the conversion of the output direction is achieved by the rolling of the roller portion 215a. Accordingly, the movement of the vibration member can be transmitted to the output portions 216 smoothly, and a highly accurate and quiet driving with a good controllability of the vibration type actuator 300 can be achieved.

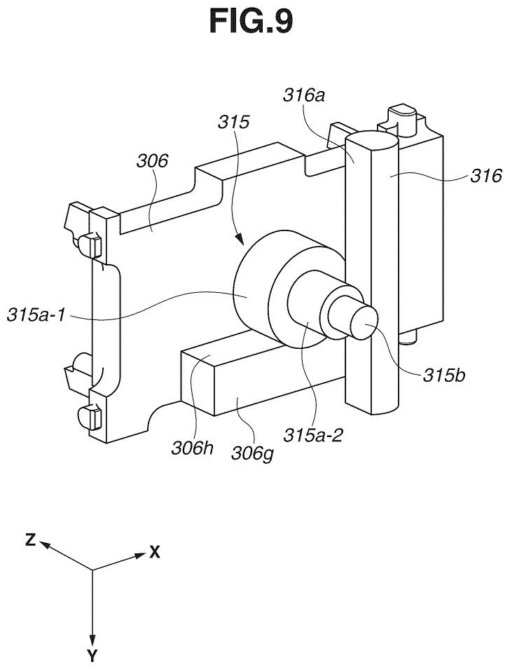

With reference to FIG. 9, a configuration example of a vibration type actuator according to a third exemplary embodiment, which has a configuration different from the configuration according to the first exemplary embodiment, will be described. The present exemplary embodiment is different in the configuration of a rotation member 315 illustrated in FIG. 9 from the configuration illustrated in FIG. 1 according to the first exemplary embodiment. Other components in the present exemplary embodiment are the same as the corresponding components according to the first exemplary embodiment, and the descriptions thereof are omitted.

FIG. 9 is a perspective view illustrating a part of a vibration type actuator 400 according to the present exemplary embodiment in an enlarged manner.

An output transmission mechanism of a vibration type actuator illustrated in FIG. 9 includes a rotation member reception portion 306g provided on a holding member 306, a rotation member 315, and an output portion 316.

The rotation member 315 includes a first roller portion 315a-1 and a second roller portion 315a-2, which are a first rotation portion and a second rotation portion serving as smooth rollers, and a rotation member shaft 315b. The first rotation portion and the second rotation portion are not limited to the smooth rollers, and may be gear-shaped rotation portions illustrated as the modification example of the first exemplary embodiment.

The two roller portions 315a-1 and 315a-2 can rotate around the Z axis that is an axis direction of the rotation member shaft 315b. The diameter of the first roller portion 315a-1 is twice as large as the diameter of the second roller portion 315a-2.

The first roller portion 315a-1 is in contact with a rotation member contact surface 306h of the rotation member reception portion 306g of the holding member 306. The rotation member contact surface 306h is a surface parallel to the XZ surface formed by a driving direction and a pressurizing direction of the vibration type actuator 300, and is a smooth surface.

The rotation member shaft 315b is fixed to a shaft fixing portion (not illustrated) of a base (not illustrated) at a position to urge a rotation member contact surface 306h and the roller portions 315a-1 and 315a-2 with a predetermined force in the Y axis direction. With this configuration, when the vibration type actuator 400 is driven, and the holding member 306 moves in the X direction, the roller portions 315a-1 and 315a-2 of the rotation member 315 rotates around the Z axis with respect to the rotation member shaft 315b by rolling on the rotation member contact surface 306h by an amount corresponding to the movement amount of the holding member 306.

The output portion 316 has a D cut surface 316a as a part of its surface, which is a flat surface parallel to the YZ plane, and is supported to be slidable with respect to the base (not illustrated) in the Y direction, and not to be able to rotate around the Y axis by the D cut surface 316a.

The D cut surface 316a is in contact with the second roller portion 315a-2 of the rotation member 315, and when the second roller portion 315a-2 rotates around the Z axis, the output portion 316 performs a translational movement in the Y direction by an amount corresponding to the rotation amount.

More specifically, when the vibration type actuator 400 is driven, and the holding member 306 performs a translational movement in the X direction, the first roller portion 315a-1, which is in contact with the rotation member reception portion 306g, and the second roller portion 315a-2 of the rotation member 315 rotate together around the Z axis. Further, the output portion 316 that is in contact with the second roller portion 315a-2 performs a translational movement in the Y direction. In this way, the translational movement of the vibration type actuator 400 in the X direction is converted into the translational movement of the output portion 316 in the Y direction in a manner reduced in speed at a ratio of 2:1 and is output.

In this way, the relative movement direction of a vibration member (not illustrated) and a contact member (not illustrated) of the vibration type actuator 400 can be converted and output, and thus, the dimension in the output direction of the vibration type actuator 400 can be made small.

Further, by making the diameter of the second roller portion 315a-2 half the diameter of the first roller portion 315a-1, it is possible to output at a speed reduced at a reduction ratio of 2 times and to make the thrust force of the vibration type actuator 400 double. Thus, since the relationship between the thrust force and the speed can be changed depending on the specification of a target object to be driven, by the diameters of the two roller portions (i.e., first roller portion 315a-1 and second roller portion 315a-2) of the rotation member 315, the vibration type actuator 400 can be used for various kinds of target objects to be driven.

In addition, in the present exemplary embodiment, ratio between the diameters of the first roller portion 315a-1 and the second roller portion 315a-2 as a speed reduction mechanism is set to 2:1, but it is not limited thereto, and may be changed as appropriate. However, the larger the thrust force becomes, the smaller the speed and the movement amount become.

Further, the second roller portion 315a-2 may be made larger in diameter than the first roller portion 315a-1, to be used as a speed increasing mechanism. In this way, it is possible to output at a speed faster than the speed of the relative movement between the vibration member and the contact member of the vibration type actuator 400. At the same time, the stroke can be made longer. However, the thrust force becomes smaller by that amount.

Further, the rotation member 315 is configured to include the two roller portions 315a-1 and 315a-2 different in diameter, but the configuration is not limited thereto. For example, the rotation member 315 may be configured to include two gears different in diameter, and each of the rotation member reception portion 306g and the output portion 316 may be provided with a rack.

Further, the movement of the vibration type actuator 400 in the X direction is reduced in speed and converted into a movement the Y direction, but it is not limited thereto.

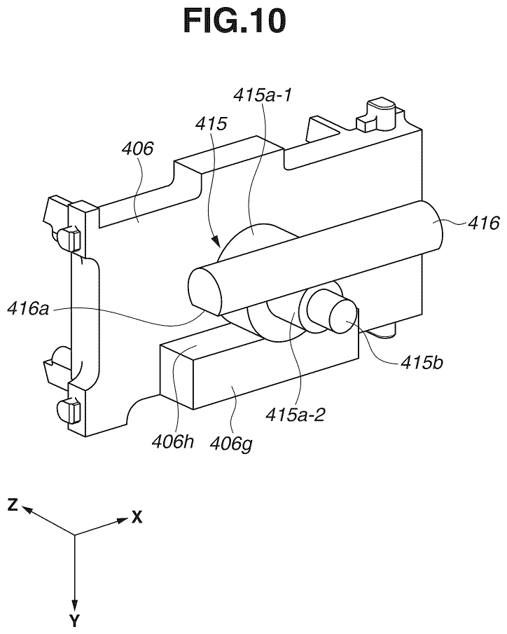

For example, as a modification example of the present exemplary embodiment illustrated FIG. 10, an output portion 416 may be configured to move to be in the same direction as the X direction (i.e., first direction). In this way, a vibration type actuator according to this modification example is driven, and a holding member 406 performs a translational movement in the X direction from the left to the right in FIG. 10. Further, a first roller portion 415a-1, which is in contact with a rotation member reception portion 406g, and a second roller portion 415a-2 of a rotation member 415 rotate together around the Z axis (i.e., rotation member shaft 415b). The output portion 416 that is in contact with the second roller portion 415a-2 translates in the Y direction from the right to the left in FIG. 10.

In other words, it is possible to obtain an output in the same output direction as the X direction, and in a reversed direction at a reduced speed.

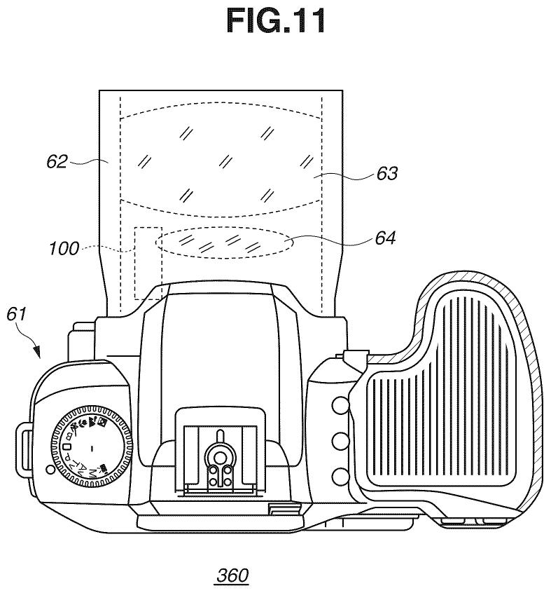

FIG. 11 is a top view schematically illustrating an imaging apparatus 360 serving as an example of an optical apparatus including the vibration type actuator 100 according to the first exemplary embodiment of the present disclosure. The imaging apparatus 360 includes an imaging apparatus body 61 provided with an imaging element (not illustrated) on which light having passed through lenses (described below) forms an image, and a lens barrel 62 attachable to and detachable from the imaging apparatus body 61. The lens barrel 62 includes a lens group 63 (lenses) including a plurality of lenses, a focusing lens 64 (lens), which are examples of optical elements, and the vibration type actuator 100. A lens holding frame (not illustrated) holding the focusing lens 64 is connected to the output portion 16 serving as a moving member in the vibration type actuator 100. By driving the vibration type actuator 100, the focusing lens 64 is driven in an optical axis direction to focus on an object.

In a case where a zoom lens is provided in the lens barrel 62, the vibration type actuator 100 also can be used as a driving source to move the zoom lens in the optical axis direction.

Further, an image shake correction lens is provided in the lens barrel 62, the vibration type actuator 100 can be used as a driving source to drive the image shake correction lens in a plane orthogonal to the optical axis.

The present disclosure has been described above based on the exemplary embodiments, but the present disclosure is not limited to the specific exemplary embodiments, and various forms made within the range not departing from the scope of the present disclosure are also included in the present disclosure. Further, the above-described exemplary embodiments are merely examples of the present disclosure, and it is possible to combine the exemplary embodiments as appropriate.

The present disclosure of the exemplary embodiments includes the following configurations.

### [Configuration 1]

A vibration type actuator including a vibration member including an electro-mechanical energy conversion element and an elastic member, a contact member in contact with the vibration member, the vibration member and the contact member being configured to relatively move in a first direction, the vibration type actuator including,
a base,
a holding member held by the base and configured to hold the vibration member,
a rotation member including a rotation shaft held by the base and extending in a second direction intersecting with the first direction, and configured to be in contact with the holding member and rotate in association with the relative movement of the vibration member, and
an output portion held by the base to be movable in a third direction intersecting with the second direction, and configured to be in contact with the rotation member and move in association with a rotation of the rotation member.

### [Configuration 2]

The vibration type actuator according to Configuration 1, in which the rotation member is shorter in length than the holding member in the third direction, and is located on an inner side of a position where the holding member is located.

### [Configuration 3]

The vibration type actuator according to Configuration 1 or 2, in which the rotation member is shorter than the holding member in length in the first direction and in length in the third direction, and is located inside an area projected by the holding member, in a plane including the first direction and the third direction.

### [Configuration 4]

The vibration type actuator according to any one of Configurations 1 to 3,
in which the rotation member includes a roller-shaped rotation portion, and
in which the rotation portion is in contact with the holding member.

### [Configuration 5]

The vibration type actuator according to any one of Configurations 1 to 3,
in which the rotation member includes a gear-shaped rotation portion, and
in which the holding member includes a rack portion that is configured to engage with and be in contact with the rotation portion.

### [Configuration 6]

The vibration type actuator according to any one of Configurations 1 to 5,
in which the vibration type actuator includes two output portions, and
In which the two output portions move in directions opposite to each other in the third direction.

### [Configuration 7]

The vibration type actuator according to any one of Configurations 1 to 6,
in which the rotation member includes a first rotation portion configured to be in contact with the holding member, and a second rotation portion configured to be in contact with the output portion, and
in which the first rotation portion and the second rotation portion are different in diameter.

### [Configuration 8]

The vibration type actuator according to Configuration 7, in which the first rotation portion is larger than the second rotation portion in diameter.

### [Configuration 9]

The vibration type actuator according to Configuration 7, in which the first rotation portion is smaller than the second rotation portion in diameter.

### [Configuration 10]

The vibration type actuator according to any one of Configurations 1 to 9, in which the first direction and the third direction are approximately orthogonal.

### [Configuration 11]

The vibration type actuator according to any one of Configurations 1 to 9, in which the first direction and the third direction are a same direction.

### [Configuration 12]

The vibration type actuator according to any one of Configurations 1 to 11, in which the vibration member is rectangular, and a longer side direction of the vibration member and the first direction are a same direction.

### [Configuration 13]

The vibration type actuator according to any one of Configurations 1 to 12, in which the elastic member includes two protrusions, and the two protrusions and the contact member are in contact with each other.

### [Configuration 14]

An optical apparatus including,
the vibration type actuator according to any one of Configurations 1 to 13, and
at least one of an optical element and an imaging element to be driven by the vibration type actuator.

### [Configuration 15]

An electronic apparatus including,
a member, and
the vibration type actuator according to any one of Configurations 1 to 13 configured to drive the member.

According to the exemplary embodiments of the present disclosure, it is possible to provide a vibration type actuator with the design flexibility improved. In addition, according to the exemplary embodiments of the present disclosure, it is possible to provide an optical apparatus and an electronic apparatus including the vibration type actuator with the design flexibility improved.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-169958, filed Sep. 29, 2023, which is hereby incorporated by reference herein in its entirety.

What is claimed is:

1. A vibration type actuator including a vibration member including an electro-mechanical energy conversion element and an elastic member, and a contact member in contact with the vibration member, the vibration member and the contact member being configured to relatively move in a first direction, the vibration type actuator comprising:
a base;
a holding member held by the base and configured to hold the vibration member;
a rotation member including a rotation shaft held by the base and extending in a second direction intersecting with the first direction, and configured to be in contact with the holding member and rotate in association with the relative movement of the vibration member; and
an output portion held by the base to be movable in a third direction intersecting with the second direction, and configured to be in contact with the rotation member and move in association with a rotation of the rotation member.

2. The vibration type actuator according to claim 1, wherein the rotation member is shorter in length than the holding member in the third direction, and is located on an inner side of a position where the holding member is located.

3. The vibration type actuator according to claim 2, wherein the rotation member is shorter than the holding member in length in the first direction and in length in the third direction, and is located inside an area projected by the holding member, in a plane including the first direction and the third direction.

4. The vibration type actuator according to claim 1,
wherein the rotation member includes a roller-shaped rotation portion, and
wherein the rotation portion is in contact with the holding member.

5. The vibration type actuator according to claim 1,
wherein the rotation member includes a gear-shaped rotation portion, and
wherein the holding member includes a rack portion configured to engage with and be in contact with the rotation portion.

6. The vibration type actuator according to claim 1,
wherein the vibration type actuator includes two output portions, and
wherein the two output portions move in directions opposite to each other in the third direction.

7. The vibration type actuator according to claim 1,
wherein the rotation member includes a first rotation portion configured to be in contact with the holding member, and a second rotation portion configured to be in contact with the output portion, and
wherein the first rotation portion and the second rotation portion are different in diameter.

8. The vibration type actuator according to claim 7, wherein the first rotation portion is larger than the second rotation portion in diameter.

9. The vibration type actuator according to claim 7, wherein the first rotation portion is smaller than the second rotation portion in diameter.

10. The vibration type actuator according to claim 1, wherein the first direction and the third direction are approximately orthogonal.

11. The vibration type actuator according to claim 1, wherein the first direction and the third direction are a same direction.

12. The vibration type actuator according to claim 1, wherein the vibration member is rectangular, and a longer side direction of the vibration member and the first direction are a same direction.

13. The vibration type actuator according to claim 1, wherein the elastic member includes two protrusions, and the two protrusions and the contact member are in contact with each other.

14. An optical apparatus comprising:
the vibration type actuator according to claim 1; and
at least one of an optical element and an imaging element configured to be driven by the vibration type actuator.

15. An electronic apparatus comprising:
a member; and
the vibration type actuator according to claim 1 configured to drive the member.
